(19) United States
(12) Patent Application Publication
(10) Pub. No.: US 2015/0326652 A1
(43) Pub. Date: Nov. 12, 2015

(54) System and method of transferring dynamic data in real time through wireless, server-less communication between a immobile computing device and a mobile computing device

(71) Applicant: Kerry Lee Davis, San Jose, CA (US)

(72) Inventor: Kerry Lee Davis, San Jose, CA (US)

(21) Appl. No.: 14/710,587

(22) Filed: May 12, 2015

Related U.S. Application Data
(60) Provisional application No. 61/991,852, filed on May 12, 2014.

(51) Int. Cl. H04L 29/08; H04W 4/00

(52) U.S. Cl. CPC H04L 67/104; H04W 4/008

(57) ABSTRACT

A system and a method is configured for transferring dynamic data in real time through wireless, server-less communication between a immobile computing device and a mobile computing device.

The current application claims a priority to the U.S. Provisional Patent application Ser. No. 61/918,852 filed on May 12, 2014.

### FIELD OF THE INVENTION

The present invention is in the technical field of standalone near field communications (i.e. communication without cloud server assistance) between a desktop/laptop/pad Internet browser and a mobile Internet phone equipped device for purposes of cross device/platform data transfer.

### BACKGROUND OF THE INVENTION

Internet Browsers were invented to provide a somewhat standard screen (as opposed to command line) graphical user interface for user surfing of the world wide web (aka Internet). Browsers have grown dramatically with respect to complexity and increased functionality as Internet appliances have added features and sensor capabilities, especially in the case of mobile telecommunications devices also known as “smart phones”. One particular feature which has had a direct effect on mobile browsers directly aimed for use on smart phones, is the ability for the browser to make embedded phone numbers clickable for the user such that clicking the number will bring up a dialer popup pre-populated with the phone number. This is commonly referred to as one click dialing.

Because phone service is not inherently available, immobile or desktop browsers inherently do not provide cellular phone service and therefore do not make phone numbers embedded in web pages one click dial-able or clickable. Some VoIP providers like Skype, which have desktop apps, have overcome this hurdle by adding browser extensions which extend the capability of desktop browsers to identify and make clickable embedded phone number text so that the user may utilize one click dialing directly to their specific VoIP app resident on the desktop with the browser. This is a reasonably popular idea as Skype has reportedly had over 50 million downloads of their click to call browser extensions.

Taking this idea in a slightly different way, Google has developed a browser extension which performs a similar function to identify embedded phone numbers on their desktop Chrome browser (developed by Google) and pass those numbers when clicked to their specific Chrome to Phone Google app on an Android (also owned by Google) phone which has been paired specifically to the desktop. This transfer of information however, occurs across the Internet where several servers are required to transport the data and a fairly complicated procedure of pairing the mobile and desktop Internet appliances must first occur. While more complicated and much more restrictive than the Skype browser extension (Chrome to only Android mobile devices), Google has still been able to get around 1.2 million downloads of this extension and another 1.7 million downloads of the required mobile android app). Once again showing the popularity of one click dialing.

In addition to general information transfer and with respect to advertising and marketing, many advertising and marketing campaign are first presented to customers on a desktop browser where browser cookies play an increasingly important role. However, more and more of these desktop originated campaigns are originated on desktops but conclude on mobile devices with no way to share the originating browser cookie. As is well known, the completion of the advertising/marketing process by the user is the most valuable part of the process and because users are increasing using more and more web devices to make and complete a single purchase, following that process across multiple devices in an easy to implement manner and nonintrusive way for the user is very important.

The primary use of this present invention is to provide of method of one click data transfer from any desktop browser or smart video player to any smart phone device using a browser extension or embedded browser/player add-on, a mobile app to receive and render the data in a useful manner where the communication of the data is directly between the desktop browser and the mobile app. The data to be transferred could be, but is in no way limited to, a phone number, a web URL or a link to an ad presented on the desktop but taken on the mobile device.

The differentiation of this solution with other available inventions is that it is ubiquitous to desktop/smart phone browser or hardware and it involves a direct communication between the desktop browser and the mobile smart phone, which does not require a server interaction to either decode the message or transport it. In fact, if the data is a phone number for example, the receiving smart phone need not even have Internet service at all and likewise the desktop browser could provide a clickable phone number from a cached web page at the time of the transaction.

The current solution is particularly valuable in that it is complimentary to a browser ad rendered in real time with ad content based on the users browser history and advertiser bidding, the present invention provides a method for generating the data to be transferred in real time dependant on the changing content of the ad and not on the relatively static nature of the page hosting the ad. If a second server were required just for interpretation of the data transfer between the desktop and the mobile, a much more complicated communications link would be required between that server and the ad generating platform which would be much more complicated than the current method defined in this invention which is server-less. For example: Imagine a Google ad-sense ad you can click on and the link renders inside your mobile phone leaving your desktop on the original page. Not only does this provide a mobile ad channel not available today (namely 2nd screen content for desktop advertising) it also provides value to the user by retaining his original web page AND the web page owner who keeps the user on his page. Some ad links either intentionally or incidentally hijack the user disallowing, or at best making it difficult for, them to return to the original page. Additionally it provides a way to track a user across devices when following an ad trail to make a purchase originating on one device and terminating on another and assists in click thru payment verifications.

### SUMMARY OF INVENTION

In the present invention, a browser extension or embedded plug-in (also commonly referred to as an add-on or widget respectively) may be used to identify and make clickable some web data on or relevant to a desktop web browser and pass that data wirelessly to a receiving mobile app which can in turn open up the native phone dialer or any other VoIP/video call application or other application relevant to the passed data (such as a mobile browser in the case of the data being a URL).

One purpose of the invention is to provide the ability for a desktop browser to easily extend its functionality to include one click dialing as easily as its mobile counterpart, wherein the dialing part of the function is completed by a surrogate device with phone capability such as a smart phone and without the need for any other network components to complete the task.

While Click to Call capability is readily available on a mobile smart phone browser today, click from a desktop browser directed for calling from one or more mobile devices is quite rare and current solutions are both difficult to configure and quite restrictive where they exist. The present invention seeks to remove these aforementioned points of friction by providing a solution that is easier to configure, agnostic to hardware, operating system and possible to extend across any major browser or carrier.

### EXECUTIVE SUMMARY OF INVENTION

The method for Server-less Wireless Data Transfer from Desktop Browser to Mobile Device involves a browser extension or embedded HTML5/JavaScript widget capable of holding or identifying data which is valuable for transfer to a mobile device yet, for some convenience sake, is currently resident on a desktop device. One of the most obvious forms of data that falls into this category is embedded phone numbers within a desktop browser web page. However, there are many instances of data including but not limited to URL's (e.g. web, photo, video, music, game, app URL's just to name a few) which might also have value to capture or tag from a desktop browser and transfer directly to a mobile device.

A desktop browser extension or HTML5/JS widget, with respect to the present invention, would be equipped with the ability to transmit in its entirety and without the use of cloud servers or the need to pair the mobile device to the desktop browser, the aforementioned valuable data wirelessly and directly to a receiving app resident on the mobile device. One such method of near field transfer would involve using audio to modulate a broadcast signal between the desktop browser and the mobile device receiving app. This is a perfectly satisfactory solution where the data owner has no expectation of privacy or security with respect to the data. In cases where the data is either a phone number or URL already visible on the user's desktop web page, there would be no expectation of privacy and in fact could be quite useful for multicast simultaneously between a single desktop device and multiple mobile devices. For example, where a professor wishes to easily transmit his/her office phone number to a class of students equipped with mobile phones.

### BRIEF DESCRIPTION OF THE DRAWINGS

FIG. 1 is an illustration of a mobile to user data transfer with data translation require of the present invention.

FIG. 2 is an illustration of a mobile to user data transfer with no data translation require of the present invention.

FIG. 3 is an illustration of a desktop interactive video player to mobile of the present invention.

### DETAIL DESCRIPTIONS OF THE INVENTION

### Terminology and Lexicography

Click-to-Dial feature—Traditionally, this feature is specifically defined for a single click on an user interface to dial a phone number. However, this feature was later extended to include click to dial a voice-over internet protocol (VoIP) address. For the purposes of the present invention, this feature extends to clicking to dial or invoke any useful data for near field transfer from a immobile computing device to a mobile computing device, wherein the mobile computing device is capable of using the useful data to execute a particular task such as dialing a telephone number or rendering a target uniform resource identifier (URL) inside a mobile browser. This feature may include, but is not limited to, telephone numbers, URL's, audio, video, sponsored text/images or the invocation/rebranding of a mobile native or website application.
Desktop Browser—For purposes of the present invention, the desktop browser is a kind of content-displaying software application that is run on an immobile computing device, such as any desktop, laptop, notebook, or tablet personal computer. The desktop browser does not inherently have the click-to-dial feature.
Mobile Browser—For the purposes of the present invention, the mobile browser is resident on a mobile computing device such as a smartphone, wherein the mobile browser inherently has click-to-dial capabilities even if limited in capability.
Smart Video Player—For the purposes of the present invention, the smart video player has extended interactive capabilities to display overlaid buttons and functions relative to an interactive user request (such as touch, mouse or voice) or to display automated features based on a time position in the video.
Browser Extension (or Add-on)—For the purposes of the present invention, a browser add-on is equivalent to the browser extension. The browser extension is used to extend the capability of the desktop browser as a whole and is independent of the particular website URL being viewed at any moment.
Browser Plugin (or Widget)—For the purposes of the present invention, a browser plugin is equivalent to a browser widget. The browser plugin is embedded within a particular webpage to extend the capability of the webpage and therefor is specific to the webpage that the browser plugin is embedded into.

All illustrations of the drawings are for the purpose of describing selected versions of the present invention and are not intended to limit the scope of the present invention.

The present invention is a system and a method of sending dynamic data in real time through direct wireless communication between a desktop computing device and a mobile computing device instead of indirect communication through the Internet or a series of servers. The system of the present invention includes two main pieces of hardware: an immobile computing device and a mobile computing device. The immobile computing device is configured for better computing performance and is not configured with size restrictions because it does not need be portable. The immobile computing device can be, but is not limited to, a desktop personal computer, a laptop personal computer, a tablet personal computer, and a smart television. The mobile computing device is configured with reduced computing capabilities and size restrictions in order to maintain its portability. The mobile computing device can be, but is not limited to, a smartphone device or a personal digital assistant (PDA). The mobile computing device and the immobile computing device have a mechanism for direct wireless communication between each other. The direct wireless communication is facilitated by signals being sent between a short-range transmitter of the immobile computing device and a short-range transmitter of the mobile computing device. The mechanism for direct wireless communication can be, but is not limited to, near field communication technologies, Bluetooth technologies, and audio signals.

The method of the present invention follows an overall process that allows the immobile computing device to efficiently send dynamic data in real time to the mobile computing device. The overall process begins by running a content-displaying software application on the immobile computing device. The content-displaying software application is any kind of software that displays audiovisual, graphic, or written content to a user. The overall process continues by identifying useful information embedded into the content-displaying software application. The useful information is data that is contextually configured to be used on the mobile computing device. For example, if the content-displaying software application is a website browser and the mobile computing device is a smartphone, then the present invention would recognize a telephone number shown on the website browser as useful information to send to the smartphone. After the present invention identifies a piece of useful information, the overall process resumes by sending the useful information from the immobile computing device to the mobile computing device through direct wireless communication between the short-range transmitter and the short-range receiver. For example, if the direct wireless communication is facilitated by audio signals, then the short-range transmitter would be a speaker and the short-range receiver would be a microphone. The overall process concludes by rendering the useful information into discernable content to be accessed by through the mobile computing device. The discernable content is information displayed on the mobile computing device in such a way that is understandable by the user. For example, if the useful information is an advertisement website link, then the mobile computing device would render the associated advertisement webpage as the discernable content.

The method of the present invention follows a variety of secondary processes in order to identify useful information embedding into the content-displaying software. One such secondary process allows the user to manually select the useful information. This secondary process begins by displaying arbitrary information on the content-displaying software application. The arbitrary information is random content that the user wishes to view through the immobile computing device. The secondary process continues by prompting the user to manually select the useful information from the arbitrary information through the immobile computing device. The secondary process concludes by receiving a manual selection from the arbitrary information to be the useful information. For example, if the content-displaying software application is a website browser and the arbitrary information is an advertisement displayed on the website browser, then the user can select a redeemable mobile coupon code within the advertisement as the useful information to be sent to the mobile computing device.

Another secondary process for identifying useful information is by using the previously-defined browser extension. In order to implement this secondary process, the content-displaying software application needs to be a website browser, and the browser extension is integrated to run alongside the website browser. This secondary process begins by detecting the useful information amongst the arbitrary information displayed by the website browser by parsing through the arbitrary information with the browser extension. The browser extension for the present invention can be designed with a set of rules to locate a certain kind of content that could be useful information for the mobile computing device. Once a piece of useful information is found by parsing through the arbitrary information, the browser extension prompts the immobile computing device to send the useful information through the means of direct wireless communication. For example, if the arbitrary information is a restaurant's website and the website browser displays the restaurant's telephone number, then the browser extension would be able to parse through the restaurant's website and identify the restaurant's telephone number as the useful information to send to the mobile computing device.

Another secondary process for identifying useful information is by using the previously-defined browser plugin. In order to implement this secondary information, the content-displaying software application needs to be a website browser. In addition, the browser plugin needs to be integrated into the arbitrary information displayed by the website browser and needs to be recognizable by the content-displaying software application. This secondary process begins by the browser plugin notifying the immobile computing device of the location of useful information amongst the arbitrary information. Once the immobile computing device is notified that a piece of useful information exists amongst the arbitrary information, the browser plugin prompts the immobile computing device to send the useful information through the means of direct wireless communication. In reference to the example used for the browser extension, if the arbitrary information is a restaurant's website and the website browser displays the restaurant's telephone number, then the browser plugin would notify the immobile computing device to send the restaurant's telephone number to the mobile computing device.

Another secondary process for identifying useful information is by using the previously-defined interactive video player. In order to implement this secondary information, the content-displaying software application needs to be the interactive video player, which is used to display audiovisual information such as online video clips. This secondary process begins by notifying the immobile computing device of the useful videos amongst the audiovisual data displayed by the interactive video player. Once the immobile computing device is notified that a piece of useful information exists amongst the audiovisual information, the interactive video player prompts the immobile computing device to send the useful information through the means of direct wireless communication. For example, if the audiovisual information is a video clip advertising a restaurant and the interactive video player displays the restaurant's telephone number during the video clip, then the interactive video player would notify the immobile computing device to send the restaurant's telephone number to the mobile computing device.

In the preferred embodiment of using the interactive video player as the content-displaying software application, the audiovisual information is associated with a backend server. The backend server is notified whenever the immobile computing device begins to display the audiovisual information. The backend server is used to store a plurality of cues for the audiovisual information, and each of the plurality of cues corresponds to a specific time within the audiovisual information. Once the backend server is notified the audiovisual information has begun playing on the interactive video player, the backend server sends the plurality of cues to the immobile computing device so that the immobile computing device can generate, extract, or identify useful information during each of the plurality of cues when the interactive video player reaches its specific time within the audio visual information.

The method of the present invention follows another kind of secondary process in order to properly render the useful information into discernable content on the mobile computing device. In order to implement this secondary process, the useful information needs to be some kind of encoded data that is associated with an origination server. Some examples of encoded data are, but are not limited to, a website link or advertisement content, which are kinds of information that may need to refer back to the origination server in order to complete a proper rendering on the mobile computing device. After the encoded data arrives at the mobile computing device as the useful information, the mobile computing device sends the encoded data to an intermediate server in order to translate the encoded data into a readable format. Once the intermediate server translates the encoded data into decoded data, relevant data for the mobile computing device is extracted from the decoded data by referring back to the origination server with the decoded data. After the relevant data is sent back to the mobile computing device, the mobile computing device is then able to render the relevant data into the discernable content. In some embodiments, the mobile computing device can refer to a separate cloud server in order to render the relevant data into the discernable content. In other embodiments where the useful information is not sent to the mobile computing device as encoded data, the mobile device could still refer to a separate cloud server in order to render the useful information into discernable content.

The method of the present invention follows another kind of second process in order to implement the click-to-call feature. In order to implement this secondary process, the useful information needs to include a telephone call command and a telephone number. This secondary process begins by prompting the user to select and send the telephone call command through the immobile computing device. Once the immobile computing device receives a confirmation from the user to initiate the click-to-call feature, the immobile computing device sends the telephone call command and the telephone number to the mobile computing device through the means of direct wireless communication. The mobile computing device then executes the telephone call command in order to setup cellular communication between the mobile computing device and a telephone line associated with the telephone number.

An alternative description of the present invention begins with three main components:
1. A browser/video player extension or plug-in code (aka widget) which identifies in real time and/or is embedded with useful information on the desktop browser to be transferred to a local smart phone device where the information may be useful. The aforementioned useful data may be pre-provisioned or be provided to the extension/plug-in in real time.
2. A near field transport mechanism capable of sending the useful data to a mobile smart phone without cloud server support to either physically transmit the data or decode/translate it.
3. A receiving mobile application on the terminating mobile smart phone capable of directly decoding and rendering the data into something useful to the mobile user.

Referring to a desktop browser or embedded HTML5/JavaScript software widget equipped with an extension application capable of identifying specific valuable data but which will also allow the user to highlight data manually for transfer in certain instances. This browser extension would be valuable to the user because it would be agnostic to browser and operating system, while also inherently easy to download and use with very minimal configuration necessary as compared to other click to call solutions like the Skype Click to Call and Google Chrome to Phone extensions.

The Google Chrome to phone solution is inherently more difficult to configure because of its need to pair the mobile device directly to the browser. However this is necessary by the very nature of the design of the system and how it transfers data across the Internet. It is also necessarily more restrictive in its use because it involves a one to one relationship between the desktop browser and the mobile device, which in addition require Google registration and a multistep pairing process. The present invention by its very nature eliminates the need for these steps.

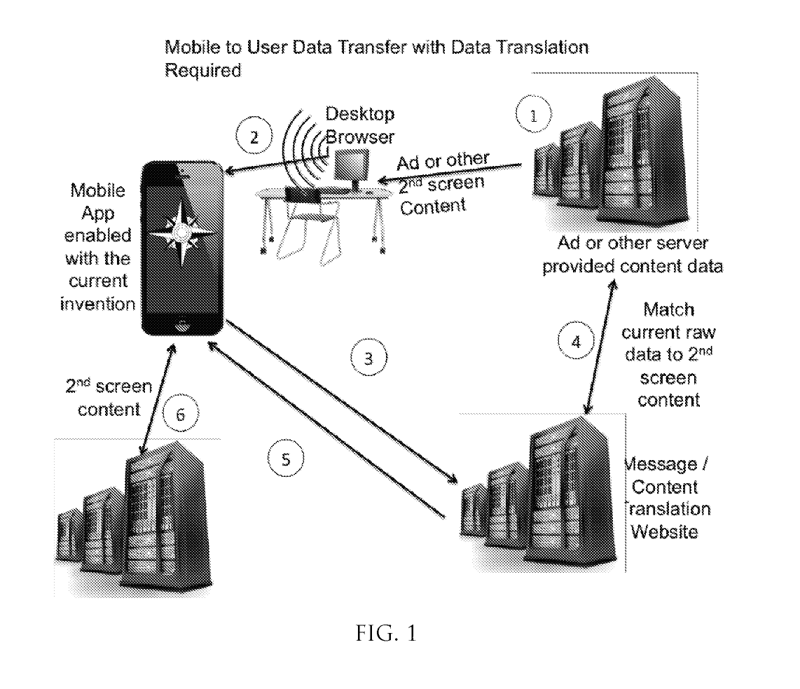

Referring now to FIG. 1 as an example of a method used by other existing platforms for conveying desktop data to a second screen mobile source.
1. Ad, phone number, URL link or other content data that is useful for transfer from a desktop device to a mobile device is embedded into a web site and served to a desktop browser.
2. A desktop browser identifies the content either via a browser extension or embedded widget and sends the data, or a link to the cloud based version of the data, in some wireless form to the mobile device.
3. The data needs to be translated to be useful and/or matched to current content to make the data relevant and therefore must be sent to another cloud server for that purpose.
4. The data is then potentially demodulated and then referenced back to the original server to be made relevant. For example, a technique called audio fingerprinting is used by the technology made popular by the Shazam app but needs to analyze a multi-second audio sample from the mobile device in order to make the signal useful. It is not known until the conclusion of this process whether the data is even useful or not and the vast majority of data is not useful but still requires an expensive process of fingerprinting a huge database of audio samples and maintaining this server.
5. Finally, the link to, or usable, data arrives back to the mobile device to be rendered or rejected by one or both of the two servers involved.
6. In some instances where the data is a link and not a phone number, for example, more cloud servers are involved to finally render the data to the 2nd screen.

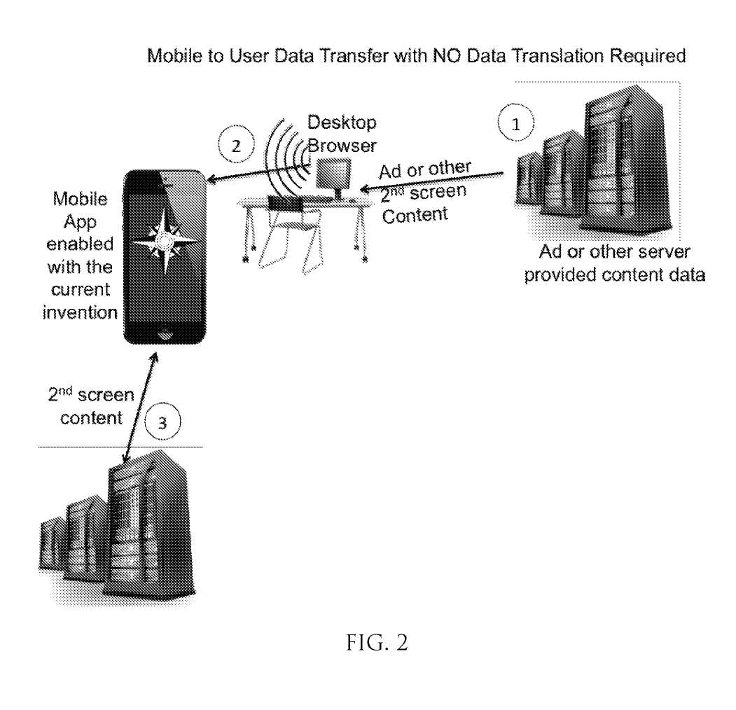

Referring now to FIG. 2 as an example of the simplified network components needed to render data using the method of this present invention.
1. Ad, phone number, URL link or other content data that is useful for transfer from a desktop device to a mobile device is embedded into a web site and served to a desktop browser.
2. A desktop browser identifies the content either via a browser extension or embedded widget and sends the data, or a link to the cloud based version of the data, in some stand alone near field wireless form to the mobile device.
3. In some instances where the data is a link and not a phone number, for example, more cloud servers are involved to finally render the data to the 2nd screen mobile application. If the data is simple enough, it can often be rendered immediately as is the case with phone numbers or SMS text data and addresses.

One might confuse an add-on such as Skype Click to Call with this present invention. However, while easier to configure and use than the Google Chrome to Phone browser extension example which is much closer in nature to the use case applied to a common but not exclusive use of the present invention, Skype Click to Call does not allow desktop to mobile click to call capability. In fact, the present invention could be integrated directly into Skype Click to Call to extend its current capability to desktop browser to mobile click-to-call from its current use of browser to app click-to-call.

Referring to a desktop browser extension within the present invention, the extension/add-on would identify or let users highlight valuable data including but not limited to phone numbers, URL's, sponsored text, images, audio and video for easy transfer to a receiving mobile device with a single click from the desktop browser.

Referring now to the part of the present invention concerning stand alone near field wireless communications and the ability to wirelessly transfer the data by audio digital modulation or other means without the use of a server to either transport or translate the data. The present invention offers at least one viable solution to this portion of the platform by referencing the audio digital modulation capabilities of the AirBridge digital mobile modulation platform invented by the author of this present invention. This form of information transfer is commonly referred to as audio watermarking because it is open air and therefore mixed with local ambient audible noise. However, audio modulation or audio watermarking is not always a standalone or direct form of communications. For example, companies such as Sonic Notify and Audio Tags both use a form of audio modulation, which requires an intermediate server to translate the signal. The server process to translate an audio watermark modulation is much simpler than the process of audio fingerprinting which requires preprocessing and database cataloging of the sound to be fingerprinted, yet they are still a form of audio watermarking that requires these extra steps. In contrast, the audio modulation scheme referenced in this present invention is in part enabled because it does not require these extra steps.

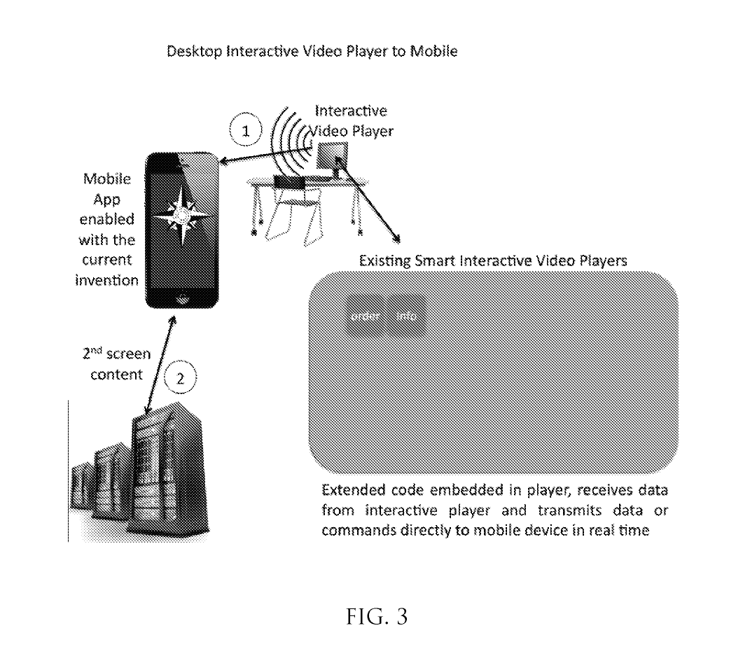

Referring now to FIG. 3; in addition to Browser Plug-ins, extensions and add-ons, sharing content interactively from a desktop to a mobile user using an extension to a smart interactive video player in real time is also covered in this present invention. Video sites such as YouTube.com and Cinsay.com currently have interactive desktop video players that could easily be extended with generic code embedded with the capabilities of the present invention. The method for accomplishing the aforementioned task of interactive communications directly between the smart interactive video player and a mobile smart device such as an iPhone or Android phone involves the following process:
1. Several smart video applications currently exist which provide an interactive user interface directly over a simple video player. This application is extended in the present invention to provide a direct transmit communication to the mobile device that can be called upon based on user interaction with the player to send relevant commands directly to the mobile device.
2. A mobile application capable of receiving and rendering the commands from the extended interactive video player processes the data from the player much the same as if the commands or data had come from a browser extension or embedded widget.

The above mentioned process in FIG. 3 is unique in the ability to embed communications code as an extension to the existing smart video players which allows them to communicate directly with the mobile device from the browser where the smart player is embedded or other stand alone application for the smart player. The code to make this feature possible from the interactive smart browser can be written in a portable web language such as Javascript and can use digital sound modulation as one possible means of communication to the mobile device without requiring external server interaction to translate the commands or data as has been demonstrated using browser extensions enabled with the present invention by the author to date.

The author of this invention recognizes that there are other possible ways to perform this particular step of near field communications, which may be deemed less appealing, such as blue tooth low energy, but nonetheless relevant. However, on its own Bluetooth Low energy or any other near field data transport represents only a small function in this broader invention in step 2 of FIG. 2 and is not relevant to the invention process as a whole.

The method and steps provided in FIG. 2 along with the necessary components as outlined in this current disclosure define the unique nature of this invention and its ability to provide cross device ad and information targeting (aka ad fingerprinting) in real time and with a simple and cost effective manner so as to make the solution viral and provide increased ease of use for venues, advertisers and users.

In some embodiments of the present invention, using an intermediate server by the mobile device applies optionally to all cases. It is not specific to the case where the present invention uses an html5 audio transmitter embedded on a source website any more than it is when the source of the transmission is a browser extension. What the mobile device does with the transmitted data it receives from the website or the browser extension or the smart video player or even a TV broadcast transmitting our signal, is independent of the transmitter itself. There are multiple ways of transmitting the useful information prerecorded or live pulses (embedded html5 code, browser extension, physical beacon, electronic signage, TV/Satellite/Web broadcast).

Although the invention has been explained in relation to its preferred embodiment, it is to be understood that many other possible modifications and variations can be made without departing from the spirit and scope of the invention as hereinafter claimed.

What is claimed is:

1. A method of transferring dynamic data in real time through wireless, server-less communication between a immobile computing device and a mobile computing device by executing computer-executable instructions stored on a non-transitory computer-readable medium, the method comprises the steps of:
providing a immobile computing device, wherein said immobile computing device is running a content-displaying software application and includes a short-range transmitter;
providing a mobile computing device, wherein said mobile computing device includes a short-range receiver;
identifying useful information embedded into said content-displaying software application with the immobile computing device in real time, wherein said useful information is contextually configured to be used on said mobile computing device;
sending said useful information from said immobile computing device to said mobile computing device through direct wireless communication between said short-range transmitter and said short-range receiver;
rendering said useful information into discernable content to be accessed through said mobile computing device;

2. The method of transferring dynamic data in real time through wireless, server-less communication between a immobile computing device and a mobile computing device by executing computer-executable instructions stored on a non-transitory computer-readable medium, the method as claimed in claim 1 comprises the steps of:
displaying arbitrary information on said content-displaying software application;
prompting to manually select said useful information from said arbitrary information through the immobile computing device;
receiving a manual selection from said arbitrary information to be said useful information;

3. The method of transferring dynamic data in real time through wireless, server-less communication between a immobile computing device and a mobile computing device by executing computer-executable instructions stored on a non-transitory computer-readable medium, the method as claimed in claim 1 comprises the steps of:
providing a browser extension integrated into said content-displaying software application, wherein said content-displaying software application is a website browser;
detecting said useful information amongst arbitrary information displayed by said website browser by parsing through said arbitrary information with said browser extension;
prompting said immobile computing device with said browser extension to send said useful information through said direct wireless communication;

4. The method of transferring dynamic data in real time through wireless, server-less communication between a immobile computing device and a mobile computing device by executing computer-executable instructions stored on a non-transitory computer-readable medium, the method as claimed in claim 1 comprises the steps of:
providing a browser plugin recognized by said content-displaying software application, wherein said content-displaying software application is a website browser, and wherein said browser plugin is integrated into arbitrary information displayed by said website browser;
notifying the immobile computing device of a location of said useful information amongst said arbitrary information with said browser plugin;
prompting said immobile computing device with said browser plugin to send said useful information through said direct wireless communication;

5. The method of transferring dynamic data in real time through wireless, server-less communication between a immobile computing device and a mobile computing device by executing computer-executable instructions stored on a non-transitory computer-readable medium, the method as claimed in claim 1 comprises the steps of:
providing an interactive video player as said content-displaying software application, wherein said interactive video player displays audiovisual information;
notifying the immobile computing device of said useful information amongst said audiovisual information with said interactive video player;
prompting said immobile computing device with said interactive video player to send said useful information through said direct wireless communication;

6. The method of transferring dynamic data in real time through wireless, server-less communication between a immobile computing device and a mobile computing device by executing computer-executable instructions stored on a non-transitory computer-readable medium, the method as claimed in claim 4 comprises the steps of:
providing a backend server associated with said audiovisual data;
notifying said backend server when said interactive computing device begins to display said audiovisual information;
sending a plurality of cues for said audiovisual data from said backend server to said immobile computing device, wherein each of said plurality of cues corresponds to a specific time within said audiovisual information;
generating said useful information at each of said plurality of cues when said interactive video player reaches said specific time within said audiovisual information;

7. The method of transferring dynamic data in real time through wireless, server-less communication between a immobile computing device and a mobile computing device by executing computer-executable instructions stored on a non-transitory computer-readable medium, the method as claimed in claim 1 comprises the steps of:
providing encoded data as said useful information, wherein said encoded data is associated with an origination server;
transmitting said encoded data from said mobile computing device to an intermediate server;
translating said encoded data into decoded data with said intermediate server;
extracting relevant data for said mobile computing device from said decoded data by referring to said origination server with said decoded data;
sending said relevant data back to said mobile computing device;
rendering said relevant data into said discernable data on said mobile computing device;

8. The method of transferring dynamic data in real time through wireless, server-less communication between a immobile computing device and a mobile computing device by executing computer-executable instructions stored on a non-transitory computer-readable medium, the method as claimed in claim 6 comprises the steps of:
referring to a separate cloud server in order to render said relevant data into said discernable data on said mobile computing device;

9. The method of transferring dynamic data in real time through wireless, server-less communication between a immobile computing device and a mobile computing device by executing computer-executable instructions stored on a non-transitory computer-readable medium, the method as claimed in claim 5, wherein said relevant data is a website link.

10. The method of transferring dynamic data in real time through wireless, server-less communication between a immobile computing device and a mobile computing device by executing computer-executable instructions stored on a non-transitory computer-readable medium, the method as claimed in claim 5, wherein said relevant data is advertising content.

11. The method of transferring dynamic data in real time through wireless, server-less communication between a immobile computing device and a mobile computing device by executing computer-executable instructions stored on a non-transitory computer-readable medium, the method as claimed in claim 1 comprises the step of:
rendering said useful information into said discernable data on said mobile computing device by referring to a separate cloud server;

12. The method of transferring dynamic data in real time through wireless, server-less communication between a immobile computing device and a mobile computing device by executing computer-executable instructions stored on a non-transitory computer-readable medium, the method as claimed in claim 1 comprises the steps of:
providing a telephone call command and a telephone number as said useful information;
prompting to select and send said telephone call command through said immobile computing device;
sending said telephone call command and said telephone number from said immobile computing device to said mobile computing device through said direct wireless communication;
executing said telephone call command in order to setup cellular communication between said mobile computing device and a telephone line associated with said telephone number;

13. The method of transferring dynamic data in real time through wireless, server-less communication between a immobile computing device and a mobile computing device by executing computer-executable instructions stored on a non-transitory computer-readable medium, the method as claimed in claim 1, wherein said direct wireless communication is through an audio signal played by said short-range transmitter and heard by said short-range receiver.
